(19) United States
(12) Patent Application Publication
(10) Pub. No.: US 2024/0280157 A1
(43) Pub. Date: Aug. 22, 2024

(54) Liquid Damper for Canceling and Damping Vibrations on Consturctions

(71) Applicants: Kersten Latz, Krummesse (DE); Sebastian Voelkel, Wismar (DE); Thomas Bittermann, Wismar (DE); Hannah Klinner, Wismar (DE); Anne Schildhauer, Wismar (DE); Kay-Hennig Kruse, Wismar (DE)

(72) Inventors: Kersten Latz, Krummesse (DE); Sebastian Voelkel, Wismar (DE); Thomas Bittermann, Wismar (DE); Hannah Klinner, Wismar (DE); Anne Schildhauer, Wismar (DE); Kay-Hennig Kruse, Wismar (DE)

(21) Appl. No.: 18/586,092

(22) Filed: Feb. 23, 2024

Related U.S. Application Data
(63) Continuation of application No. PCT/EP2022/073444, filed on Aug. 23, 2022.

(30) Foreign Application Priority Data
Aug. 24, 2021 (DE) 10 2021 121 874.8

(51) Int. Cl. F16F 7/10; E04B 1/98

(52) U.S. Cl. CPC F16F 7/1034; F16F 7/1017; E04B 1/98

(57) ABSTRACT

A liquid absorber is for absorbing and damping vibrations in structures, in particular in slender, vertically oriented structures. It is therefore an object to overcome the disadvantages of the prior art and to provide a liquid absorber which lessens the sloshing effect of a fluid in the liquid absorber. A further object is to provide a liquid absorber which achieves an increase in the damping ratio for containers with sloshing lengths of more than 80 cm. A further object is to enable fine adjustments to be made with regard to the damping ratio and to develop a vibration absorber which has optimal damping properties (“Den Hartog”) and considerably improves the response behavior over a broad frequency spectrum.

### CROSS-REFERENCE TO RELATED APPLICATIONS

This application is a continuation application of international patent application PCT/EP2022/073444, filed Aug. 23, 2022, designating the United States and claiming priority from German application 10 2021 121 874.8, filed Aug. 24, 2021, and the entire content of both applications is incorporated herein by reference.

### TECHNICAL FIELD

The disclosure relates to a liquid absorber for absorbing and damping vibrations in structures, in particular in slender, vertically oriented structures.

### BACKGROUND

Slender, vertically oriented structures such as high-voltage pylons (HVP), wind turbines (WT) and high-rise buildings (HRB) with an appropriately slender configuration may be susceptible to vibrations. Dynamic effects such as wind, earthquakes (HRB) and wave impact (offshore WT) generally encompass a broad frequency spectrum. To avoid resonance vibrations, it is necessary for the supporting structure to be either reinforced or strengthened with expensive absorption and damping measures.

Liquid absorbers of this type are employed to reduce the vibrations in chimneys, cables in cable-stayed bridges and hangers in arch bridges. “Skyscrapers” are occasionally equipped with pendulum and liquid absorbers. The basic principle of this type of vibration absorption or damping is based on the premise that fluid, in a cell not completely filled with this fluid, sloshes in the form of a wave, strikes an end wall of the cell, is reflected thereby and flows back in the opposite direction. Since the absorber is tuned to the natural vibration frequency of a structure, the forces exerted by the fluid on the cell walls counteract the vibration and thus have an absorptive effect. Optimal damping is important, however, to achieve the rapid decay of the vibration, in particular if the vibrations are excited continuously or periodically, such as those caused for example by wind or, in the case of wind turbines, also by the rotor blades, et cetera.

Although conventional absorbers are able to neutralize the first natural frequency with the absorber mass, two new resonance frequencies are produced. These can only be damped in a weak, expensive and ineffective manner using the known methods.

In order to control the effect of environmental influences and the forces resulting therefrom with dynamic effects, and to avoid resonance vibrations, the prior art discloses the following solutions.

EP 0 686 733 B2 discloses an invention which relates to a vibration damper for vibration-prone structural components or structures (B) including at least one container filled with a liquid (F), wherein the mass, the sloshing frequency and the internal damping behavior of the liquid (F) are tuned to a natural frequency of the vibration-prone structure (B) to be damped. In order to achieve quasi-rotationally symmetrical vibration behavior at low cost and with low mass, the distance (A) between each container wall (W) delimiting the liquid surfaces (O) and the center (M) of the liquid surface (O) is approximately equal on the perpendicular bisector, extending in the plane of the liquid surface (O), of the line (S) of intersection of the plane of the liquid surface (O) with the corresponding container wall (W).

The US specification U.S. Pat. No. 4,951,441 A discloses a damping device having a liquid vessel into which a liquid having a wave motion water surface is injected, such that the wave motion direction of the wave motion of the water surface is in the elongated direction of the vessel. Damping members are provided in order to damp the sloshing of liquid in the liquid vessel, and wave dissipation devices are arranged at a portion not always soaked in liquid in the liquid vessel. Accordingly, the vibration of a construction occurring as a result of wind, earthquake and the like is absorbed by the viscous resistance occurring between the liquid and the damping members, and the vibration is restricted. Moreover, damping performance can be efficiently achieved by providing various installation arrangements.

DE 3 640 479 A1 discloses an adjusting device for narrow structures having adjustable parts for active or passive deformation control with unhindered thermal expansion without an additional damping composition. To optimize the system, adjustable coupling functions are used to absorb excitation energy or convert it into damping, supporting or stabilizing reaction energy.

KR101210847B1 discloses an omnidirectional tuned liquid damper and a floating offshore wind power system having the same system to improve vibration damping efficiency, structural stability and generation efficiency by damping vibrations and shaking in all directions. An omnidirectional tuned liquid damper includes an outer wall (10) formed so as to be circular, an inner wall (20) formed so as to be circular, a base component (30), which is formed so as to be annular and connects the inner and outer walls at the bottom, and an annular cover connecting the inner and outer walls at the top in order to close a chamber (40) formed between the inner and outer walls to receive liquid and to reduce vibrations through the sloshing effect of the liquid.

Utility model CN 201 217 859 Y discloses an energy-dissipating, shock-absorbing annular water tank, which relates to an energy-dissipating and shock-absorbing device. The energy-dissipating, shock-absorbing annular building water tank is primarily used for buildings and uses a liquid damping method. The energy-dissipating, shock-absorbing annular water tank of the building is provided with at least one annular water tank, which is provided with a water inlet and a water outlet, and a water source is connected outside the water inlet and the water outlet. In use, the annular water tank is arranged horizontally on an upper level and/or a device conversion level of a building structure, and fire protection water and domestic water may be used as the liquid in the annular water tank, which is connected to a water supply system. The energy-dissipating, shock-absorbing annular water tank may be used to render the building structure shock-resistant or to improve the existing building structure; since essential fire protection and domestic water is adequately employed as a damping medium and is positioned at an appropriate height, no non-use loads (additional mass) are added to the building structure, the center of gravity of the building structure does not rise, the damping energy-dissipating effect is increased, and a larger overturning moment of a counterpart with a reverse moment is produced.

Moreover, CN103291818A discloses an invention relating to a hybrid vibration damping device with energy dissipation, including a container, a particle system and a viscous liquid. The particle system includes solid particles; the viscous liquid may be a single type of liquid, or a plurality of types of liquid are mixed with one another to form the viscous liquid, and the viscous liquid is accommodated in the container. The particle system is arranged in the viscous liquid, may float in the viscous liquid, or may be submerged at the bottom of the viscous liquid. The viscous liquid can vibrate in the container. The functional mechanism of the vibration damping device for hybrid energy dissipation is similar to the functional mechanism of a tuned liquid damper, wherein the different types of liquids rub against one other to dissipate energy, a structural restoring force is provided for the lateral pressure of the container, and structural amplitude is reduced. The solid particles of the particle system collide with and rub against one another in the container to dissipate energy. The viscous liquid rubs against the particle system or the particles to dissipate energy.

The utility model CN 201 843 734 U discloses a tower vibration control system for generating wind power based on an annular TLD (Tuned Liquid Damper), wherein the wind turbine includes a foundation, a tower frame, a cabinet, a hub, blades and the annular TLD, wherein the annular TLD is installed on the tower frame. The TLD includes an annular tube, damping nets and viscous liquid. The damping nets are arranged uniformly in the annular tube. The annular tube is filled with the viscous liquid. The annular tube is mounted at the upper end of the tower frame.

US 2009/0049767 discloses a tuned liquid damper (1) including a housing (2) with a hollow cavity (3) within the housing and a first fluid (4) which partially fills the hollow cavity. The inner surface of the hollow cavity is substantially spherical. In this way, a tuned liquid damper is provided which has a response which is constant and independent of the orientation of the tuned liquid damper.

WO2016037958 discloses a device (12) for absorbing and damping vibrations in structures, in particular slender structures, such as towers, pylons, wind turbines (13) or the like, containing at least one damper cell (20) which is partially filled with a fluid (22), which sloshes therein and only fills the damper cell to a predetermined fill level (h). In order to provide such a device, which is to be accommodated in a structurally advantageous manner, even in slender structures, and allows effective damping of excited vibrations, the damper cell has an annular space (21) with an non-separated ring shape with an internal ring height, a horizontal base (25), circumferential outer and inner walls (23, 24) and a cover wall (26) which closes the annular space at the ring height (H) from the base upward. In the fluid-free annular space (32) formed between the fluid surface (34) and the cover wall, a large number of floating elements (33), which float on the fluid surface, are provided. They allow effective and rapid damping of excited vibrations.

U.S. Pat. No. 5,560,161 A1 relates to the use of actively tuned liquid dampers for damping vibrations in large structures. The effective length of the liquid damper tank determines the natural frequency of the liquid and thus the effectiveness of the damper at particular excitation frequencies. The liquid damper presented in this document is tuned using rotating baffles to adjust the effective length of the liquid damper tank.

A disadvantage of the prior art is that although conventional absorbers are able to neutralize the first natural frequency with the absorber mass, two new resonance frequencies are produced. These can only be damped in a weak, expensive and ineffective manner using the known methods.

In use, liquid absorbers developed to date have exhibited non-linear effects at sloshing lengths of more than 80 cm (structures with natural frequencies<1 Hz). A further disadvantage of the stage of development achieved to date is that the degree of damping provided by current absorbers is too low and they are unable to set the damping ratio with precision.

The prior art does not disclose any liquid absorbers or dampers which avoid non-linear effects in use and/or increase the damping ratio in containers with sloshing lengths>80 cm and/or enable fine adjustments to be made to the damping ratio in a technically simple manner.

### SUMMARY

It is therefore an object of the disclosure to overcome the disadvantages of the prior art and to provide a liquid absorber which lessens the sloshing effect of a fluid in the liquid absorber.

A further object is to provide a liquid absorber which achieves an increase in the damping ratio for containers with sloshing lengths of more than 80 cm.

A further object of the disclosure is to enable fine adjustments to be made with regard to the damping ratio and to develop a vibration absorber which has optimal damping properties (“Den Hartog”) and considerably improves the response behavior over a broad frequency spectrum.

It is also an object of the disclosure to significantly increase the structural safety and fitness for purpose, and to markedly reduce the production costs of these structures and to preserve existing structures with vibration problems.

A further object is to provide a method with which it is possible to accurately set an optimal damping property of a liquid absorber.

The above-mentioned object is, for example, achieved by a liquid absorber for absorbing and damping vibrations, in particular for avoiding resonance vibrations and for increasing the structural safety for slender, vertically oriented structures, such as high-voltage pylons, wind turbines, high-rise buildings, floodlight pylons or the like. The liquid absorber according to the disclosure has the following components: a container for receiving a fluid and for receiving floating elements, wherein the floating elements are arranged in and/or on the fluid in such a way that they reduce the formation of a surface wave of the fluid. The liquid absorber further has a load application system which is formed to apply a force or pressure to the floating elements.

A surface wave is a wave-like transient movement of the surface of the fluid. A surface wave produced in the fluid prevents linear steady state damping behavior. Structural vibrations can, as a rule, be described very effectively by linearized equations of motion. Adding an absorber (usually a spring-mass absorber) makes it possible to manipulate the linearized vibration system in such a way that, in the event of harmonic excitation at the resonance frequency of the output system, the response amplitude is identical to 0. Two new resonance frequencies with associated mode shapes are produced. Without damping, there would therefore be two poles in the frequency range. With damping, the frequency response includes two local maxima at the new resonance positions. Assuming linear behavior, absorber damping parameters may now be used to minimize the local maxima (the “Den Hartog principle” or “Den Hartog damping”). This is only successful if the vibration behavior is completely linear. To achieve this, the additional damping provided by the absorber also has to act in an approximately linear manner. When the damping behavior is linear, the damping force is linearly dependent on speed, and the degree of damping can be set precisely.

According to different embodiments, the floating elements are arranged in a layer-like manner in and/or on the fluid to avoid the formation of a surface wave.

According to different embodiments, the floating elements are pellets and/or at least one buoyant, flexurally rigid plate. Other types of floating elements are conceivable.

To avoid the formation of a surface wave in an improved manner, at least one buoyant, flexurally rigid plate is arranged above the pellets. The pellets are preferably arranged in a layer-like manner on the surface of the fluid.

According to different embodiments, the load application system is arranged on the at least one buoyant, flexurally rigid plate. Preferably, the buoyant, flexurally rigid plate is arranged above the pellets.

Furthermore, according to different embodiments, the load application system has weights of varying mass. According to different configuration variants, the load application system is configured in such a way that fine adjustments can be made to the damping ratio via a variable selection of the weights. This is achieved by applying a force, in particular the inherent force of the weights, to the floating elements, causing the floating elements, in particular the pellets, to be pressed into the fluid. The selection of the weight to be applied influences the friction between the floating elements and therefore influences the degree of damping.

According to an alternative embodiment, the load application system has a plunger with a drive unit, so a force is applied as required via the plunger to the floating elements via the drive unit. The selection of the amount of force to be applied influences the friction between the floating elements and therefore influences the degree of damping.

Furthermore, according to different configuration variants, the liquid absorber according to the disclosure has a control and regulation unit. The control and regulation unit is configured so as to receive and process input variables in order to generate output variables based on the input variables. Using the output variables, the control and regulation unit can activate the load application system based on the input variables in such a way that a weight is applied to the floating elements via the load application system. In this manner, a force is applied to the floating elements, causing the floating elements, in particular the pellets, to be pressed into the fluid. This force can be regulated by the control and regulation unit in a manner adapted to the current vibration situation and, as a result, the degree of damping provided by the liquid absorber is continuously variable and/or can be finely adjusted.

Furthermore, it is conceivable that the liquid absorber according to the disclosure has a device for adapting a sloshing length and/or for adapting a fill level, wherein this device for adapting a sloshing length and/or for adapting the fill level is configured in such a way that it can change a sloshing length in the container and/or wherein this device for adapting a sloshing length and/or for adapting the fill level is configured in such a way that it can change a fill level of the fluid in the container. To change the fill level, the corresponding device may have a pump system and/or a discharge and feed system for filling the container with fluid and/or for emptying the container. Furthermore, the corresponding device for changing the sloshing length may have a variably displaceable vertical wall in or on the container. Other means which may be employed to change the fill level and/or to change the sloshing length are conceivable.

The object is also achieved by a method for absorbing and damping vibrations in a finely adjusted manner via a liquid absorber, in particular for avoiding resonance vibrations and for increasing the structural safety for slender, vertically oriented structures. The method has the following method steps:
a) recording of input variables,
b) calculation of a required degree of damping based on the input variables recorded,
c) introduction of floating elements into a liquid absorber,
d) determining a force based on the required degree of damping and applying this force to floating elements arranged in layers in the liquid absorber.

The input variables to be recorded are for example the acceleration of the structure, the amplitude of the structural vibration, the period of the structural vibration, wind speeds and/or a change in the imposed loads. The required degree of damping is derived from the resonating absorber mass, an absorber frequency and/or the absorber damping. Some of the input variables may be recorded for example via sensors and/or on the basis of current weather data.

The dimensions of the floating elements are determined in accordance with the degree of damping to be achieved on the basis of different parameters, for example size, shape, material, form and quantity of the floating elements. The floating elements may for example take the form of pellets or be plate-shaped. It is conceivable to use floating elements which differ from one another. The dimensions of the floating elements are determined in such a way that, together with the force to be applied, the desired/determined degree of damping is achieved. The dimensions are determined for example by calculation and/or experimentally. The force to be applied is also determined by calculation, for example via CFD simulation, and/or experimentally.

A layer-like arrangement of the floating elements causes a sharp rise in the degree of damping. By applying force, for example via weights, a degree of damping of up to at least 10% may be achieved. Furthermore, the degree of damping can be finely adjusted by applying force.

The above-mentioned object of the disclosure is achieved by improving the damping properties of the liquid absorbers. This is achieved, for example, by adding a large number of small, buoyant elements (“pellets”), made for example of expanded polystyrene or cork, to the liquid containers in order to reduce the sloshing movements of the water surface very rapidly and thus to dampen the structural vibrations. Non-linear effects are avoided for example by installing at least one floating, rigid plate over the pellets. Furthermore, applying ballast to the plate presses the buoyant elements together and thus increases friction, which is directly associated with an increase and/or manipulation of the damping ratio. This allows fine adjustments to be made and a significant increase in damping to be achieved.

With respect to the structure to be built, employing the fluid absorber according to the disclosure enables the user to significantly improve the response behavior (damping properties) over a broad frequency spectrum, to increase the structural safety and fitness for purpose and to reduce the production costs of the structure. The effectiveness of the damper is increased. This makes it possible to reduce the cost of materials and construction. In the case of existing structures, these can be saved, avoiding the need to build new structures.

### BRIEF DESCRIPTION OF DRAWINGS

The invention will now be described with reference to the drawings wherein:

FIGS. 1A and 1B show a liquid damper according to the prior art;

FIGS. 2A to 2C show a liquid damper with a layered arrangement of the floating elements;

FIG. 3 shows a liquid absorber with a flexurally rigid plate on pellets;

FIG. 4 shows a liquid absorber for making fine adjustments to damping, having pellets, a flexurally rigid plate and a load application system; and,

FIG. 5 shows the possibility of making fine adjustments to the degree of damping.

### DETAILED DESCRIPTION

In the description, reference is made to the accompanying drawings which show, by way of illustration, specific embodiments in which the arrangement according to the disclosure may be implemented. In this respect, direction-related terminology such as “top”, “bottom”, et cetera, is used with reference to the orientation of the drawings described. The direction-related terminology is provided for illustrative purposes and is not limiting in any way.

It is understood that other embodiments may be used, and structural or logical modifications may be made, without departing from the scope of protection of the present disclosure. It is understood that the features of the various example embodiments described herein may be combined with one another, unless specifically stated otherwise. The following detailed description is therefore not to be interpreted in a limiting manner, and the scope of protection of the present disclosure.

In the figures, identical or like elements are provided with identical reference signs where expedient.

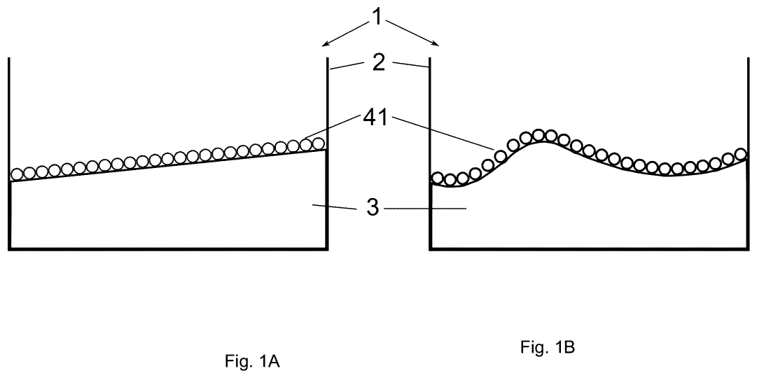

FIG. 1A shows a liquid absorber 1 known in the prior art. These liquid absorbers have a container 2 with a liquid 3 on which floating elements 4, for example pellets 41 made of expanded polystyrene, cork or similar materials, float. The damping ratio can be influenced and controlled by varying the quantity of pellets. For structures with a first natural frequency of over 1 Hz and correspondingly small containers in which a sloshing length of less than 80 cm is achieved, a desired degree of damping can be set precisely. However, linear damping behavior is only possible if the surface of the fluid 3 remains planar. If, however, the first natural frequency of the structure to be protected is less than 1 Hz, but the containers are required to have a sloshing length of more than 80 cm, a surface wave is produced when the fluid 3 sloshes (FIG. 1B). This results in a transient and non-linear process which does not bring about the desired and/or required damping behavior.

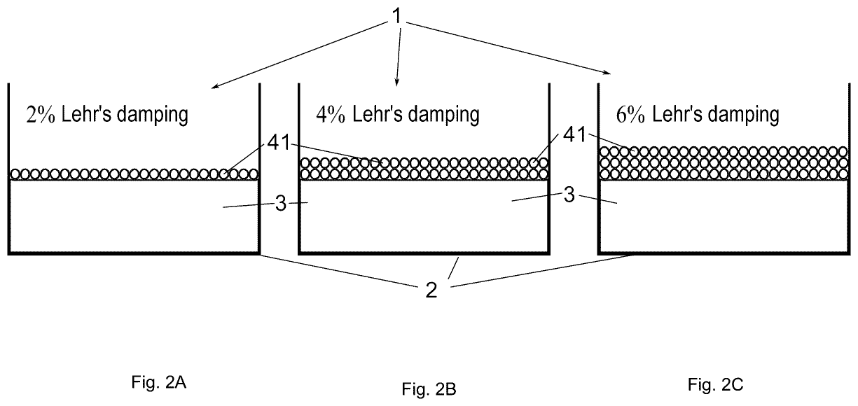

FIGS. 2A to 2C show a liquid absorber 1 having a container 2 which is formed to receive a liquid 3. Floating elements 4, for example pellets 41, are arranged on the liquid 3. In FIG. 2A, the pellets are arranged in a single layer and achieve, for example, in a container with defined dimensions, a degree of damping (Lehr's damping) of 2%. In FIG. 2B, the pellets 41 are arranged in two layers, achieving a degree of damping of 4% with the same container dimensions as in FIG. 2A. In FIG. 2C, the pellets 41 are arranged in three layers, achieving a degree of damping of 6% with the same container dimensions as in FIGS. 2A and 2B. The disadvantage in this case is that, although the layered arrangement of the floating elements increases the degree of damping, the degree of damping rises in large increments only. “Den Hartog damping” for optimizing an absorber requires the degree of damping to be set precisely, but intermediate levels, for example 3%, 2.5% or 5% (in relation to the degrees of damping mentioned in FIGS. 2A to 2C, are not possible. Furthermore, the increase in the degree of damping provided by the layer-like arrangement of the floating elements (pellets) is limited: for containers with long sloshing lengths, above a certain quantity of pellets, further increasing the number of layers no longer leads to an increase in damping. Consequently, in this example, a required degree of damping of more than 6% is not achievable.

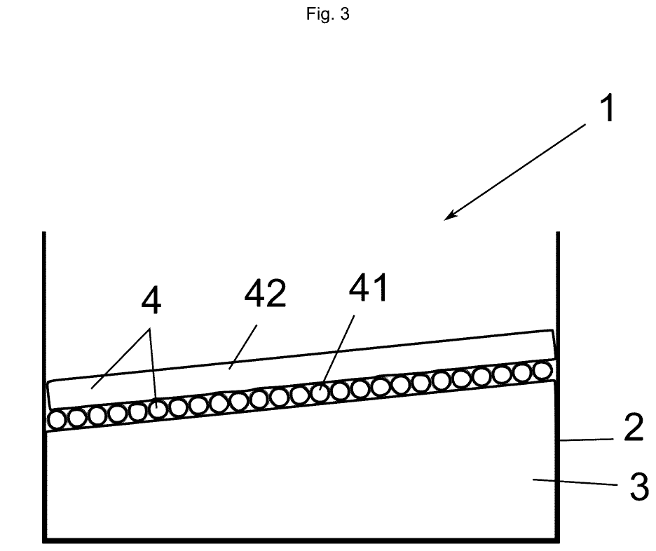

Arranging a buoyant, flexurally rigid plate 42 above the pellets 41 suppresses the surface wave (as shown in FIG. 1B and thus imposes linear sloshing behavior (shown schematically in FIG. 3).

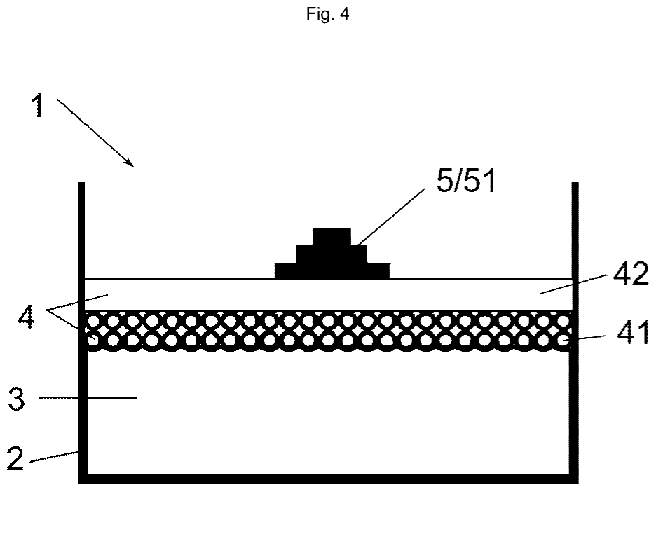

The problems explained in relation to FIGS. 1A to 2C can be solved by the liquid absorber 1 according to the disclosure (shown in FIG. 4). The liquid absorber 1 according to the disclosure for absorbing and damping vibrations, in particular for avoiding resonance vibrations and for increasing the structural safety for slender, vertically oriented structures, has the following components: a container 2 for receiving a fluid 3 and for receiving floating elements 4, wherein the floating elements 4 are arranged in and/or on the fluid 3 in such a way that they reduce the formation of a surface wave of the fluid 3. The liquid absorber further has a load application system 5 for applying a force to the floating elements 4.

According to different embodiments, the floating elements 4 are arranged in a layer-like manner in and/or on the fluid 3 to avoid the formation of a surface wave.

According to different embodiments, the floating elements 4 of the liquid absorber according to the disclosure are pellets 41 and/or at least one buoyant, flexurally rigid plate 42.

To avoid the formation of a surface wave, the buoyant, flexurally rigid plate 42 according to different embodiments is arranged above the pellets 41.

According to different embodiments, the load application system 5 is preferably arranged on the at least one buoyant, flexurally rigid plate 42, wherein the buoyant, flexurally rigid plate 42 is preferably arranged above the pellets 41. It is also conceivable, however, to use a plurality of buoyant, flexurally rigid plates 42, with or without the use of pellets 41.

Furthermore, the load application system 5 has weights 51 of varying mass, wherein, according to different embodiments, the load application system 5 is configured in such a way that fine adjustments are made to a damping ratio via a variable selection of the weights 51, such that adapting the weight 51 influences the friction between the pellets 4 and thus leads to an increase in and/or manipulation of the degree of damping.

An alternative configuration variant of the load application system 5 of the liquid absorber 1 is that the load application system 5 has a plunger with a drive unit (not shown in the figures). In this case, the load is not applied by selecting different weights, but by applying force via the plunger, which is pressed onto the floating elements by the drive unit.

Furthermore, according to different embodiments, the liquid absorber according to the disclosure may have a control and regulation unit which is configured so as to receive and process input variables in order to subsequently generate output variables based on the input variables. The control and regulation unit may subsequently use the output variables generated to activate the load application system (based on the input variables) in such a way that a force is applied to the floating elements 4 via the load application system. The force applied, which acts on the floating elements, for example the pellets 4, presses the latter into the fluid 3. It is conceivable that the force is regulated via feedback relating to the current vibration situation, which makes it possible to continuously adapt the damping ratio of the liquid absorber 1.

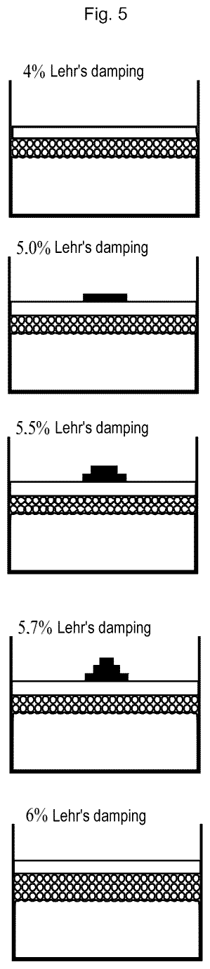

Applying a force, for example via weights 51, to the floating elements 4, increases the friction between the floating elements 4 and thus increases the degree of damping. The problems described in relation to FIGS. 1A to 2C can be solved by the specific arrangement of the floating elements 4, wherein the pellets 41 are arranged in a layer-like manner on the liquid 3 and at least one flexurally rigid, buoyant plate 42 is arranged on the pellets 41: higher degrees of damping of up to at least 10% may also be achieved by the action of force, and it is possible to make fine adjustments to the degree of damping, as shown in FIG. 5.

Furthermore, it is conceivable that the liquid absorber 1 according to the disclosure has a device for adapting a sloshing length and/or for adapting a fill level, wherein this device for adapting a sloshing length and/or for adapting the fill level is configured in such a way that it can change a sloshing length in the container 2 and/or wherein this device for adapting a sloshing length and/or for adapting the fill level is configured in such a way that it can change a fill level of the fluid in the container 2. To change the fill level, the corresponding device may have a pump system and/or a discharge and feed system for filling the container 2 with fluid and/or for emptying the container 2. Furthermore, the corresponding device for changing the sloshing length may have a variably displaceable wall in or on the container 2. Other means which may be employed to change the fill level and/or to change the sloshing length are conceivable.

It is understood that the foregoing description is that of the preferred embodiments of the invention and that various changes and modifications may be made thereto without departing from the spirit and scope of the invention as defined in the appended claims.

### REFERENCE SIGNS

1 liquid absorber
2 container
3 fluid
4 floating elements
4.1 pellets
4.2 buoyant, flexurally rigid plate
5 load application system
5.1 weights
5.2 plunger

1.-13. (canceled)

14. A liquid absorber for absorbing and damping vibrations in a structure, the liquid absorber comprising:
a plurality of floating elements;
a fluid;
a load application system;
a container configured to receive said fluid and to receive said plurality of floating elements;
said plurality of floating elements being arranged at least one of in and on said fluid such that said plurality of floating elements reduce a formation of a surface wave of said fluid; and,
said load application system being arranged on said plurality of floating elements in order to exert a force on said plurality of floating elements.

15. The liquid absorber of claim 14, wherein said plurality of floating elements are arranged in a layer-like manner at least one of in and on said fluid.

16. The liquid absorber of claim 14, wherein said plurality of floating elements are pellets.

17. The liquid absorber of claim 14, wherein one of said plurality of floating elements is a buoyant, flexurally rigid plate.

18. The liquid absorber of claim 16 further comprising a buoyant, flexurally rigid plate arranged above said pellets.

19. The liquid absorber of claim 14, wherein said load application system has weights of varying mass.

20. The liquid absorber of claim 19, wherein said load application system is configured such that fine adjustments are made to a damping ratio via a variable selection of said weights of varying mass.

21. The liquid absorber of claim 16 further comprising:
a buoyant, flexurally rigid plate arranged above said pellets;
said load application system being arranged on said buoyant, flexurally rigid plate.

22. The liquid absorber of claim 14, wherein said load application system has a plunger with a drive unit.

23. The liquid absorber of claim 14 further comprising:
a control and regulation unit configured to receive and process input variables in order to generate output variables based on the input variables; and,
said control and regulation unit being configured to activate said load application system via the output variables based on the input variables such that the force is applied to said plurality of floating elements via said load application system.

24. The liquid absorber of claim 14 further comprising:
an adaptation device for at least one of adapting a sloshing length and adapting a fill level; and,
said adaptation device being configured to change at least one of a fill level of said fluid in said container and a sloshing length of said fluid in said container.

25. The liquid absorber of claim 24, wherein, to adapt the fill level, said adaptation device has at least one of a pump system and a discharge and feed system for at least one of filling said container with fluid and emptying said container.

26. The liquid absorber of claim 24, wherein, to adapt the sloshing length, said adaptation device has a variably displaceable wall in or on said container.

27. The liquid absorber of claim 25, wherein, to adapt the sloshing length, said adaptation device has a variably displaceable wall in or on said container.

28. The liquid absorber of claim 14, wherein the structure is a slender, vertically oriented structure.

29. A method for absorbing and damping vibrations in a structure, via a liquid absorber, wherein the liquid absorber has a container and a fluid located therein, the method comprising:
a) recording of input variables;
b) calculating a required degree of damping based on the input variables recorded;
c) introducing a plurality of floating elements into the liquid absorber such that the plurality of floating elements are arranged in layers in the container of the liquid absorber at least one of in and on the fluid; and,
d) determining a force based on the required degree of damping and applying this force to the plurality of floating elements in the liquid absorber.

30. The method of claim 29, wherein the structure is a slender, vertically oriented structure.
